(19) United States
(12) Patent Application Publication
(10) Pub. No.: US 2021/0370988 A1
(43) Pub. Date: Dec. 2, 2021

(54) PACKAGE LOCKER UNIT AND PACKAGE DELIVERY MANAGEMENT

(71) Applicant: Vincent Cheng, Burnaby (CA)

(72) Inventor: Vincent Cheng, Burnaby (CA)

(21) Appl. No.: 17/335,212

(22) Filed: Jun. 1, 2021

(30) Foreign Application Priority Data
Jun. 2, 2020 (CA) 3081629

(51) Int. Cl. B60W 60/00; G09F 3/00; E05F 15/70; B60P 3/00; B60W 10/30; G01S 19/42; A47G 29/14

(52) U.S. Cl. CPC B60W 60/00256; G09F 3/0297; E05F 15/70; G09F 2003/022; B60W 10/30; G01S 19/42; A47G 29/141; B60P 3/007

(57) ABSTRACT

A package delivery system for an automated delivery management of one or more packages is provided. The package delivery system may include a package locker unit and a control network. The package locker unit includes at least one adjustable access point, at least one pallet tower and at least one adjustable door assembly slidably. The at least one pallet tower includes a plurality of adjustable racks. The adjustable door assembly slidably coupled to the at least one pallet tower and defines an adjustable access point to access the package from the respective pallet of the respective rack. The control network is configured to facilitate customized automatic operation of the at least one adjustable door assembly while loading and delivery of the one or more packages.

### FIELD OF THE INVENTION

The present invention relates to delivery vehicles and automated management of deliveries of packages using automated delivery vehicles and associated components thereto.

### BACKGROUND OF INVENTION

Delivery services including mail/post services, courier services, transport/shipping services by manufacturers/merchants, supermarkets facilitate in delivering goods like letters, documents, books, electronic items, appliances, packages, parcels, retail goods, groceries, (hereinafter referred to as “packages”), from one location to the other. Typically, the delivery service providers employ a large number of delivery vehicles including trucks and trailers to move the packages between desired locations. Such delivery systems require human operators to perform various tasks of delivery services like labelling of packages, sorting and arranging the packages, loading and unloading of packages, delivering the packages to customers etc.

Currently, there exists a number of solutions for delivering parcel and packages to customers. Some of these solutions involve autonomous driving vehicles equipped with lockers for storing and securing the loaded packages to be transported. However, such autonomous vehicles use standard locker or container that has typically low holding capacity and therefore fails to meet the needs of the industry. Further, the door setup of such locker is fixed and is therefore not very adaptive according to the different sizes of the packages. This allows the locker to accommodate only limited size of the packages. Furthermore, the fixed door system's cost of manufacturing is higher with a lot of capacity and utility. In addition, the vehicles do not have the ability to load all sizes of packages into the lockers.

Some companies have been developing small single package delivery vehicles like drones, wheels robots or legged robots. However, these solutions fail to meet all the needs of the industry and costumer because the cost of implementing these strategies is a bit expensive. The costs of manufacturing and maintenance of these devices are high as the technology involve in this is expensive and it would also require many specialized personnel for its regular repair and upkeep. Other solutions attempt to use stationary fitted door parcel package locker to distribute parcel packages to customers. These lockers require manual stocking and are expensive to manufacture. These also have limited holding capacity with fixed package sizes. The cost savings of the lockers are therefore limited since human drivers are still required to drive to the locker and manually load the lockers. Further, the retrieval of the packages by the customers is a slow process as the customers need to travel some distance to reach the locker. Other solutions use the industry-standard delivery trucks with human drivers. The employees manually sort packages at the back of the truck and walk a package to the customer for its delivery. This solution is very time-consuming, labor-intensive and resource-intensive. This solution also has a limitation of processing the delivery during a business day, thus making the delivery the least productive. This highly inefficient delivery solution accounts for approximately 40% of the courier delivery cost. Some retail companies also ask customers to go to retrieve the product at pick up points or curb pick up at the store location. Many times, if customers are unavailable at the delivery location and miss to receive the delivery, they need to go to the pick up drop off location to retrieve the package. This brings major hassle to the customers. Sometimes the delivery person may leave the package at the front door of the house which may get stolen, misplaced or lost, thereby costing the customer and delivery companies in terms of compensation and replacement of the stolen goods.

Further, it may be quite time consuming to retrieve the packages from the vehicles in existing models of the locker. This is due to the fact that the existing provisions uses manual sorting and arranging the packages, and thus face the issue of delay. Also, the space of the lockers is not utilized in full capacity. Almost one third of space is left for the driver or manual labour to walk down and search for the package for retrieval.

In view of the above, the present invention as disclosed herein, aims to provide a novel method and a system for automated management of deliveries of packages using automated delivery vehicle and its associated components.

### SUMMARY OF THE INVENTION

In order to provide a holistic solution in the field of package delivery services, a system and a method are discussed herein for providing automated package delivery mechanism and associated devices. The present invention discloses the construction and usage of novel package lockers and a network of computer implemented devices and applications for facilitating in the automated delivery management of packages.

An object of the present invention is to construct a package locker having at least one adjustable access point to facilitate access of packages by authorized customers or intended recipients of the respective packages.

Another object of the present invention is to provide at least one adjustable door assembly for creating the at least one adjustable access point.

Another object of the present invention is to provide a control network in communication with one or more databases, each configured to facilitate in automated management of the package deliveries in a secure manner.

In view of the above objects, in one aspect of the present disclosure, a package delivery system for an automated delivery management of one or more packages is provided. The package delivery system may include a package locker unit and a control network. In one embodiment, the package locker unit includes at least one adjustable access point, at least one pallet tower and at least one adjustable door assembly slidably. The at least one pallet tower includes a plurality of racks. The plurality of racks is placed one above the other and that each rack of the plurality of racks are adjustable with respect to adjacent top and bottom racks of the plurality of racks. Each rack of the plurality of racks includes a plurality of pallets placed adjacent to each other for form the rack. Further, each pallet of the plurality of pallets are movable with respect to other pallet. Each pallet is capable of accommodating a package of one or more packages to be delivered. Furthermore, the at least one adjustable door assembly is slidably coupled to the at least one pallet tower. The at least one adjustable door assembly is adjected to provide the at least one adjustable access point to access the package accommodated on a respective pallet of the plurality of pallet of a respective rack of the plurality of racks. The at least one adjustable door assembly includes a rolling shutter door assembly and a sliding shutter door assembly. The rolling shutter door assembly is coupled to the at least one pallet tower to slide vertically. The rolling shutter door assembly includes a plurality of horizontally extending members stacked together and vertically adjustable with respect to each other to create a first adjustable access point. Further, the sliding shutter door assembly is coupled to the at least one pallet tower behind the rolling shutter door assembly to slide horizontally. The sliding shutter door assembly includes a plurality of vertically extending members stacked together and horizontally adjustable with respect to each other to create a second adjustable access point. The first and second adjustable access points coincide together to collectively configure at least one adjustable access point to access the package from the respective pallet of the respective rack. The control network is configured to: facilitate customized automatic operation of the at least one adjustable door assembly while loading and delivery of the one or more packages, facilitate flexible stack formation inside the at least one pallet tower for shelving the one or more packages according to different package sizes, provide access of the package to its authorized recipient from the at least one adjustable access point, and restrict access of the package to a recipient other than the authorized recipient.

According to an embodiment of the present disclosure, the package locker unit is installed on one of a driverless vehicle, and a vehicle with a driver or on a stationary structure or installed independently.

According to an embodiment of the present disclosure, the customized automatic operation of the at least one adjustable door assembly includes automatically opening and closing of the at least one adjustable access point during delivery of the one or more packages.

According to an embodiment of the present disclosure, the customized automatic operation of the at least one adjustable door assembly includes automatically opening of the at least one door according to various sizes of the one or more packages to be loaded and delivered.

According to an embodiment of the present disclosure, the control network is in communication with a global positioning system (GPS) device configured to identify locations including a source location, a destination location and a current location of each of the one or more packages.

According to an embodiment of the present disclosure, an identification (ID) label is allotted to each of the one or more packages.

According to an embodiment of the present disclosure, the identification (ID) label is implemented by the control network while storing, loading and delivering the one or more packages.

According to an embodiment of the present disclosure, one or more databases are communicably connected to each other and with the control network in a communication network. The one or more databases includes: at least one customer database configured to store details of one or more customers to whom the one or more packages are to be delivered; at least one package database configured to store details of one or more packages; and at least one courier database configured to store information of one or more warehouse or courier services.

According to an embodiment of the present disclosure, the at least one adjustable access point is being configured on dynamic locations on a surface of the at least one tower pallet.

According to an embodiment of the present disclosure, the control network is configured to perform analysis to uniquely arrange each of the one or more packages into respective slots, respective pallets, respective pallet tower and respective vehicle.

According to an embodiment of the present disclosure, the control network comprises one or more devices including any electronic communication devices, user devices, scanner devices, sensors, bar code readers, camera devices, mobile phones, server, and computer networks for providing management of package delivery.

A package locker unit includes at least one adjustable access point, at least one pallet tower and at least one adjustable door assembly slidably. The at least one pallet tower includes a plurality of racks. The plurality of racks is placed one above the other and that each rack of the plurality of racks are adjustable with respect to adjacent top and bottom racks of the plurality of racks. Each rack of the plurality of racks includes a plurality of pallets placed adjacent to each other for form the rack. Further, each pallet of the plurality of pallets are movable with respect to other pallet. Each pallet is capable of accommodating a package of one or more packages to be delivered. Furthermore, the at least one adjustable door assembly is slidably coupled to the at least one pallet tower. The at least one adjustable door assembly is adjected to provide the at least one adjustable access point to access the package accommodated on a respective pallet of the plurality of pallet of a respective rack of the plurality of racks. The at least one adjustable door assembly includes a rolling shutter door assembly and a sliding shutter door assembly. The rolling shutter door assembly is coupled to the at least one pallet tower to slide vertically. The rolling shutter door assembly includes a plurality of horizontally extending members stacked together and vertically adjustable with respect to each other to create a first adjustable access point. Further, the sliding shutter door assembly is coupled to the at least one pallet tower behind the rolling shutter door assembly to slide horizontally. The sliding shutter door assembly includes a plurality of vertically extending members stacked together and horizontally adjustable with respect to each other to create a second adjustable access point. The first and second adjustable access points coincide together to collectively configure at least one adjustable access point to access the package from the respective pallet of the respective rack.

In one embodiment, the package locker unit further includes a slidable arrangement to slidably engage the plurality of racks to be placed one above the other and be adjustable with respect to each of the adjacent top or bottom racks of the plurality of racks to define an adjustable slot between the adjacent top and bottom racks.

In one embodiment, the package locker unit further includes a support structure disposed below the at least one pallet tower. The support structure includes a channel.

In one embodiment, the package locker unit further includes a pallet slot ID corresponding to each pallet of the plurality of pallets.

In one embodiment, each pallet of the plurality of pallets includes a plurality of pallet square. Each pallet square is movably coupled to each of an adjacent pallet square.

In one embodiment, the package locker unit further includes a pallet track system operatively coupled to the plurality of pallets to load the plurality of pallets and to maneuver the plurality of pallets within the at least one pallet tower.

In one embodiment, the at least one adjustable door assembly slidably further includes a rolling shutter door storage and a sliding shutter door channel. The rolling shutter door storage is coupled to the rolling shutter door assembly to store the rolling shutter door assembly when the rolling shutter door assembly is slid vertically to create the first adjustable access point. Further, the sliding shutter door channel is coupled to the sliding shutter door assembly to slide the rolling shutter door assembly one above the other to create the second adjustable access point, when the sliding shutter door assembly is slid horizontally.

According to an embodiment of the present disclosure, a method for facilitating automated management of delivery of one or more packages is provided. The method comprises: configuring a package locker having at least one pallet tower; configuring at least one adjustable access point on at least one surface of the at least one pallet tower, the at least one pallet tower having: a plurality of racks placed one above the other, each rack of the plurality of racks being adjustable with respect to adjacent racks of the plurality of racks, each rack of the plurality of racks having a plurality of pallets placed adjacent to each other for form the rack, wherein each pallet of the plurality of pallets are movable with respect to other pallet, each pallet accommodating a package of one or more packages to be delivered via the at least one adjustable access point; at least one adjustable door assembly slidably coupled to the at least one pallet tower, the at least one adjustable door assembly is adjected to provide the at least one adjustable access point to access the package accommodated on a respective pallet of the plurality of pallet of a respective rack of the plurality of racks, the at least one adjustable door assembly having: a rolling shutter door assembly coupled to the at least one pallet tower to slide vertically, the rolling shutter door assembly including a plurality of horizontally extending members stacked together and vertically adjustable with respect to each other to provide a first adjustable access point, a sliding shutter door assembly coupled to the at least one pallet tower in front of the rolling shutter door assembly to slide horizontally, the sliding shutter door assembly including a plurality of vertically extending members stacked together and horizontally adjustable with respect to each other to provide a second adjustable access point, wherein the first and second adjustable access points coincide together to collectively configure at least one adjustable access point to access the package from the respective pallet of the respective rack; configuring a control network for: facilitating customized automatic operation of the at least one adjustable door assembly while loading and delivery of the one or more packages, facilitating flexible stack formation inside the at least one pallet tower for shelving the one or more packages according to different package sizes, providing access of the package to its authorized recipient from the at least one adjustable access point, and restricting access of the package to a recipient other than the authorized recipient.

The afore-mentioned objectives and additional aspects of the embodiments herein will be better understood when read in conjunction with the following description and accompanying drawings. It should be understood, however, that the following descriptions, while indicating preferred embodiments and numerous specific details thereof, are given by way of illustration and not of limitation. This section is intended only to introduce certain objects and aspects of the present invention, and is therefore, not intended to define key features or scope of the subject matter of the present invention.

### BRIEF DESCRIPTION OF THE DRAWINGS

The figures mentioned in this section are intended to disclose exemplary embodiments of the claimed system and method. Further, the components/modules and steps of a process are assigned reference numerals that are used throughout the description to indicate the respective components and steps. Other objects, features, and advantages of the present invention will be apparent from the following description when read with reference to the accompanying drawings.

FIG. 1 is a block diagram of a package delivery system for providing automated delivery management of one or more packages, according to an exemplary embodiment of the present invention;

FIG. 2 illustrates a package locker unit in accordance with an exemplary embodiment of the present disclosure;

FIGS. 3A to 3E illustrate various arrangements of pallet towers of the package locker unit of FIG. 2, in accordance with various embodiments of the present disclosure;

FIGS. 4A and 4B, respectively illustrate pallets and pallet sections to form the rack, in accordance with various embodiments of the present disclosure;

FIGS. 5A to 5D illustrate movement of the pallets, the pallet squares, and the pallet sections in the pallet tower are depicted, in accordance with various embodiments of the present disclosure;

FIGS. 6A and 6B illustrate perspective views of an adjustable door assembly slidably, in accordance with various embodiments of the present disclosure;

FIG. 6C illustrates a front view of the adjustable door assembly slidably, in accordance with an embodiment of the present disclosure;

FIG. 6D illustrates a side view of the adjustable door assembly slidably, in accordance with an embodiment of the present disclosure;

FIGS. 7A and 7E illustrate a package locker unit installed on a vehicle, in accordance with various embodiments of the present disclosure; and

FIGS. 8A and 8B illustrate a package locker unit installed on a stationary structure, in accordance with various embodiments of the present disclosure;

FIGS. 9A and 9C illustrate a package locker unit installed independently, without any moving or stationary structures, in accordance with various embodiments of the present disclosure;

FIG. 10A illustrates stationary pallet tower in the package locker unit that are installed on the stationary structure or installed independently, in accordance with various embodiments of the present disclosure;

FIGS. 10B and 10C illustrate a moving pallet tower placing the package in the installed the stationary structure or installed independently, in accordance with an exemplary embodiment of the present disclosure; and

FIG. 11 illustrate a method for providing automated delivery management of one or more packages, according to an exemplary embodiment of the present invention.

### DETAILED DESCRIPTION OF THE INVENTION

This section is intended to provide explanation and description of various possible embodiments of the present invention. The embodiments used herein, and various features and advantageous details thereof are explained more fully with reference to non-limiting embodiments illustrated in the accompanying drawings and detailed in the following description. The examples used herein are intended only to facilitate an understanding of ways in which the embodiments herein may be practiced and to further enable the person skilled in the art to practice the embodiments used herein. Also, the examples/embodiments described herein should not be construed as limiting the scope of the embodiments herein. Corresponding reference numerals indicate corresponding parts throughout the drawings.

An automated package locker and delivery management of one or more packages from warehouse to respective customers are described. The automated package locker is configured to provide formation of at least one adjustable access point to enable the customers to access respective package after secure verification of the identity. At least one adjustable door assembly, having a rolling shutter door assembly and a sliding shutter door assembly, is operated to automatically form the at least one adjustable access point. A control network is configured to provide customized adjustment of the at least one adjustable door assembly while loading, stacking and delivering the one or more packages.

As used herein, ‘control network’ comprises a network of devices including computer devices, user devices, scanner devices, sensors, bar code readers, camera devices, mobile phones and computer networks for providing management of package delivery. These devices are smart electronic device capable of communicating with other electronic devices and applications via one or more communication networks. The devices connected in the network may comprises: an input unit to receive one or more input data; an operating system to enable the user device to operate; a processor to process various data and information; a memory unit to store initial data, intermediary data and final data; and an output unit. The ‘control network’ may be configured to execute specific functions or computer instructions for performing various method steps and processes, according to the embodiments disclosed herein.

As used herein, ‘one or more database’ includes at least one customer database configured to store details of one or more customers to whom the one or more packages are to be delivered; at least one package database configured to store details of one or more packages; and at least one courier database configured to store information of one or more warehouse or courier services. The one or more database may also refer to local or remote memory device, storage device, docket systems capable to store data, information, metadata, transaction details, location details, and GPS data. In an embodiment, the one or more database may be a database server, a cloud storage.

As used herein, ‘communication network’ includes a local area network (LAN), a wide area network (WAN), a metropolitan area network (MAN), a virtual private network (VPN), an enterprise private network (EPN), Internet, and a global area network (GAN).

Terms such as ‘connect’, ‘couple’ and other similar terms include a physical connection, a wired connection, a wireless connection, a logical connection or a combination of such connections including electrical, optical, RF, infrared, Bluetooth or other transmission media, as may be obvious to a person skilled in the art.

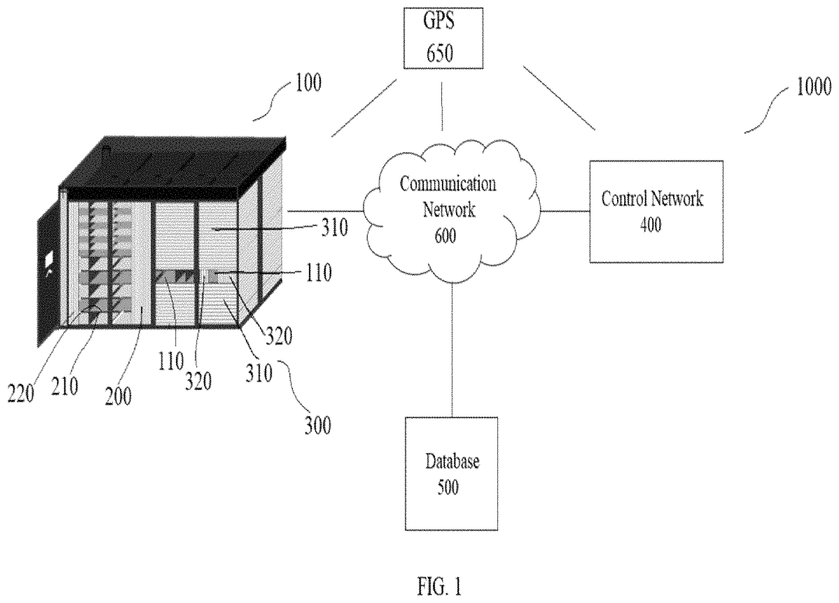

Referring now to FIG. 1, a block diagram of a package delivery system 1000 (herein after may also be referred to as ‘system 1000’ or ‘system’) for providing automated delivery management of one or more packages, according to an exemplary embodiment of the present invention is disclosed. The system 1000 includes a package locker unit 100, a control network 400 and one or more database 500 communicatively connected to each other in a communication network 600. The system 1000 facilitates in loading of deliverable items such as one or more packages, parcel packages etc., into the package locker unit 100, and also facilitates in delivering the one or more packages or parcel packages and other deliverable items to customers without employing human labor and associated cost therein. The system 1000 as disclosed herein, may be implemented in the delivery service industries to increase efficiency, security, quick turn around and cost effectiveness.

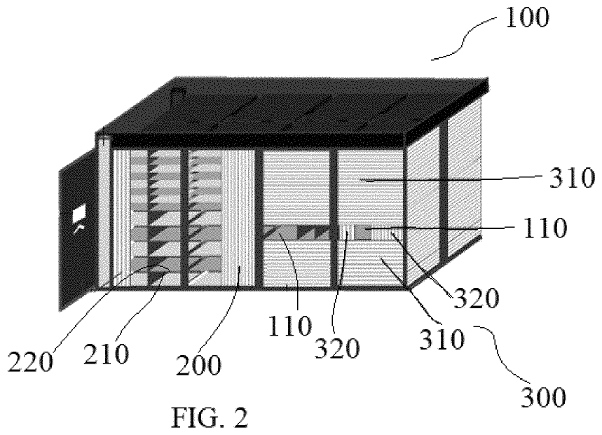

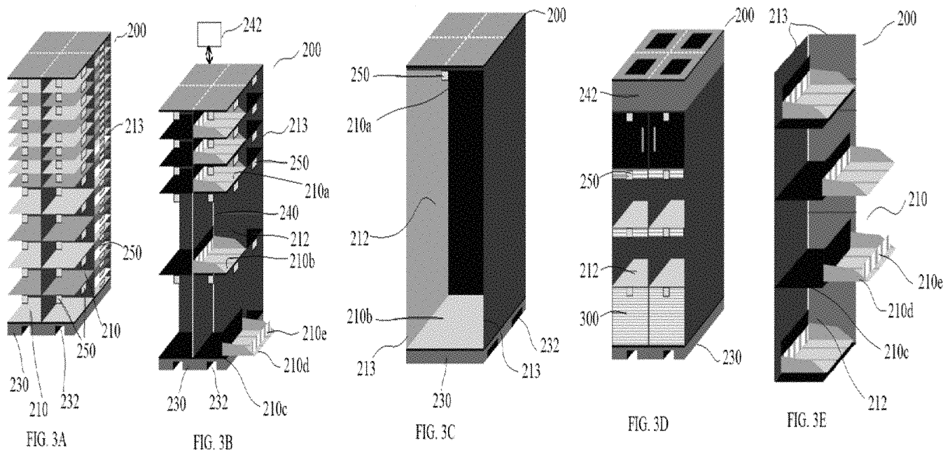

In one exemplary embodiment of the present disclosure, as shown in FIG. 2, the package locker unit 100 will now in described in conjunction to FIG. 1 and FIGS. 3A to 3E. As show in FIG. 2, the package locker unit 100 includes at least one adjustable access point 110, at least one pallet tower 200, and at least one adjustable door assembly slidably 300, which enables the formation of the at least one adjustable access point 110 on the package locker unit 100.

In one embodiment of the present disclosure, as shown in FIGS. 3A to 3E, and will be described in conjunction with FIG. 2, the at least one pallet tower 200 (herein after may also be referred to as ‘pallet tower 200’) includes a plurality of racks 210 (or racks 210). As shown in FIGS. 3A to 3E, the pallet towers are shown to depict only racks 210, without adjustable door assembly slidably 300. The plurality of racks 210 are placed one above the other and that each rack 210 of the plurality of racks 210 are adjustable with respect to adjacent top 210a and bottom 210b racks of the plurality of racks 210, as shown in FIG. 3B. In one embodiment, the package locker unit 100 may also includes a slidable arrangement 240 to slidably engage the plurality of racks 210 to be placed one above the other and be adjustable with respect to each of the adjacent top 210a or bottom 210b racks of the plurality of racks to define an adjustable slot 212 between the adjacent top 210a and bottom 210b racks. In one embodiment, the slidable arrangement 240 may be driven by a hydraulic driving system or a pneumatic driving system 242, which may apply pressure mechanism to slide each rack, such as racks 210a, 210b, of the plurality of racks 210 along the slidable arrangement 240. As described, FIG. 3A illustrates various racks 210 stacked one above the other in equidistance relation from each other to define the slots 212 that are of same size and shape in order to accommodate packages of same or various sizes. Further, FIG. 3B illustrates various racks 210, in which some of the racks are adjected to define a bigger slot, such as slots 212 to accommodate the packages of bigger sizes. Further, FIG. 3C illustrates one slot 212 between the top 210a and the bottom 210b racks and incorporating side walls 213. Such side walls 213 are also shown in FIGS. 3A and 3B. Furthermore, FIG. 3D depicts various slots, which certain slots are depicted to include the adjustable door assembly slidably 300. Moreover, FIG. 3E illustrates racks 210 that may be slid out from the pallet tower 200. In such an arrangement, the rack 210 may include a stationary rack 210c coupled to the side walls 213, and a movable rack 210d provided on the stationary rack 210c. The movable rack 210d may be slid out of the pallet tower 200 over the stationary tower to receive or deliver the package within or out of the pallet tower 200. In one embodiment, the movable rack 210d may include a barricade member 210e to prevent the package from falling out of the movable rack 210d. The stationary rack 210c and the moveable racks 210d may combinedly slidable in a vertical direction over the slidable arrangement 240, however, during the movement of the movable rack 210d out of the pallet tower 200, the stationary rack 210c may be stationary and does not move out of the pallet tower 220.

In one embodiment of the present disclosure, as shown in FIGS. 3A, 3B and 3D, the package locker unit 100 may further include a support structure 230 disposed below the pallet tower 200. The support structure 230 may include a channel 232, which may be used to engage a fork of a fork lift to lift the package locker unit 100 to load and unload thereto on a suitable system, such as any movable system such as vehicle or any stationary system, such as stationary pallets. The channel 232 may also be used to engage with a complementary channel (not shown) configured on the vehicle or the stationary pallet.

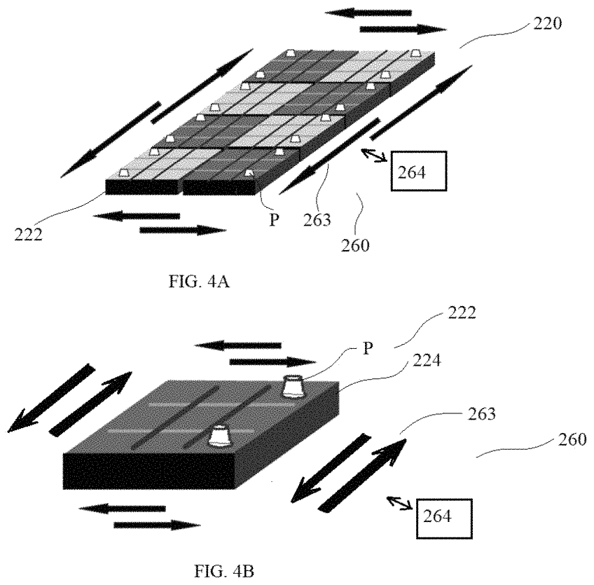

Referring now to FIGS. 4A and 4B, and will be described in conjunction with FIGS. 1 to 3E, each rack 210 of the plurality of racks 210 includes a plurality of pallets 220 placed adjacent to each other to form the rack 210. Further, each pallet 220 of the plurality of pallets 220 are movable with respect to other pallet 220. Each pallet 220 is capable of accommodating at least one package to be delivered. Further, each pallet 220 of the plurality of pallets 220 comprises a plurality of pallet square 222. Each pallet square 222 movably coupled to each of an adjacent pallet square 222, as shown in FIG. 4A. Further, as shown in FIG. 4B, each pallet square 222 may further include various pallet sections, such as pallet sections 224. Such pallet sections 224 may include the package, such as the package ‘P’. Further each of these pallet sections 224 may also be movable with respect to each other. Depending upon the size of the package, the pallet squares 222 and the pallet sections 224 may be adjustable and movable to accommodate the package. For example, if the package size is bigger and requires more than one pallet squares 222 or pallet sections 224 to accommodate such bigger package, then the number of pallet squares 222 or the pallet sections 224 accommodating such bigger package may be considered as one pallet squares 222 or one pallet sections 224 and accordingly move combinedly to maneuver the package to deliver. In various embodiments, the pallet square 222 includes very modular design that may be arranged or modified or accommodated as per the requirement of the delivery industry.

In one embodiment, the package locker unit 100 further includes a pallet track system 260 operatively coupled to the plurality of pallets 220 to load the plurality of pallets 220 and to maneuver the plurality of pallets 220 including the pallet square 222 and the pallet section 224 within the at least one pallet tower 200. In one embodiment, such pallet track system 260 may include a belt and pully arrangement 262 and a drive motor 264. The belt and pully arrangement 262 may include one or more belts and pully, which may be coupled to each of the pallet squares 222 and the pallet sections 224 to move or adjust the each of the pallet squares 222 and the pallet sections 224, individually or combinedly, depending upon the size of the package. However, without departing from the scope of the present disclosure, the pallet track system 200 may be various other maneuvering arrangement, such as hydraulic or pneumatized maneuvering arrangements.

In one embodiment of the present disclosure, the package locker unit 100 as shown in FIGS. 3A to 3D, may also include a pallet slot ID 250 corresponding to each or one of the pallets 200, the pallet square 222, and the pallet sections 224. The pallet slot ID 250 keeps all the relevant information related to the package and in is in communication with the control server 400, and will be described herein below in detail.

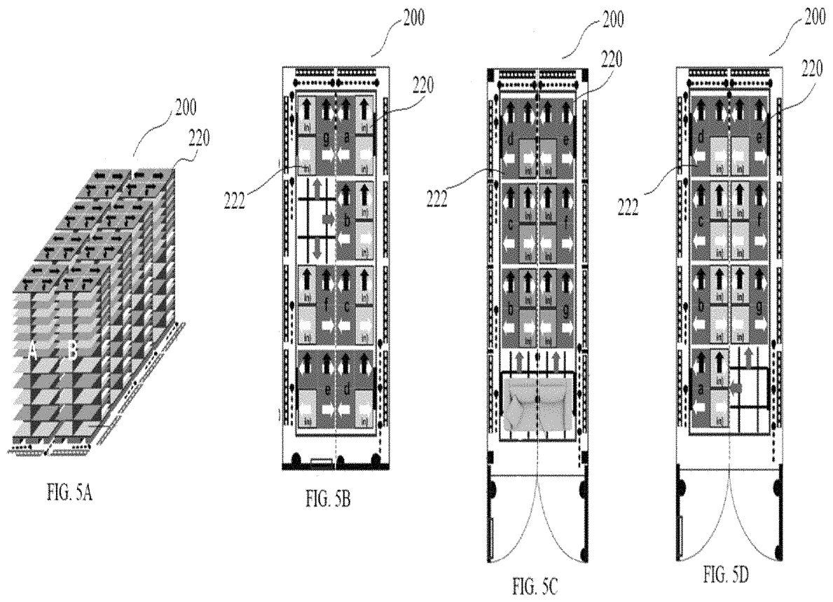

Referring now to FIGS. 5A to 5D, various embodiments of the movement of the pallets 200, the pallet squares 222, and the pallet sections 224 in the pallet tower 200 are depicted. For example, FIG. 5A illustrates a perspective view of the pallet tower 200 incorporating the pallets 200, the pallet squares 222, and the pallet sections 224, which are configured to move within the pallet tower 200. Reference ‘A’ and ‘B’ in FIG. 5A depicts tower pallet row. FIGS. 5B to 5D illustrate top vide of the pallet tower depicting the movement of the pallets 200, the pallet squares 222, and the pallet sections 224. Various arrows in the FIGS. 5B to 5D illustrates directional movement of the pallets 200, the pallet squares 222, and the pallet sections 224 in the pallet tower 200. References ‘a’, ‘c’, ‘d’, e′, ‘f’ and ‘g’ illustrate number of pallet tower per row and the movement thereof with respect to each other by arrow. FIG. 5B illustrates the pallet tower 200 loaded on vehicle wherein a container of the vehicle is closed. Further, FIGS. 5C and 5D illustrates the pallet tower 200 loaded on vehicle wherein the container of the vehicle is opened.

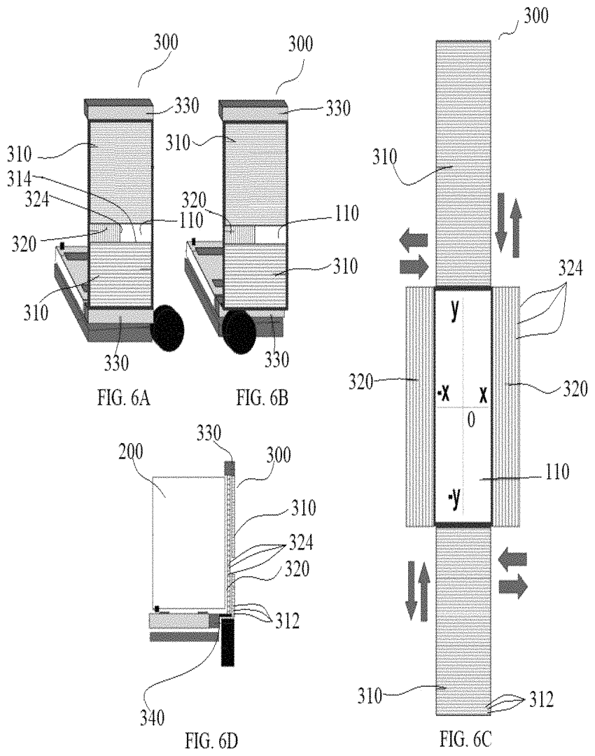

Referring now to FIGS. 6A to 6D, various views of the adjustable door assembly slidably 300 are illustrated, in accordance with an exemplary embodiment of the present disclosure. For example, FIGS. 6A and 6B illustrate perspective views of the adjustable door assembly slidably 300. FIG. 6C illustrates a front view of the adjustable door assembly slidably 300. FIG. 6D illustrates a side view of the adjustable door assembly slidably 300. The adjustable door assembly slidably 300 will be described herein in conjunction to FIGS. 1 to 5D. As shown, the adjustable door assembly slidably 300 is coupled to the pallet tower 200. The adjustable door assembly 300 is adjected to provide the adjustable access point 110 to access the package accommodated on a respective pallet 220 of the plurality of pallet of a respective rack 210 of the plurality of racks. The adjustable door assembly 300 includes a rolling shutter door assembly 310 and a sliding shutter door assembly 320. The rolling shutter door assembly 310 is coupled to the pallet tower 200 to slide vertically. The rolling shutter door assembly 310 includes a plurality of horizontally extending members 312 stacked together and vertically adjustable with respect to each other to create a first adjustable access point 314. Further, the sliding shutter door assembly 320 is coupled to the at least one pallet tower 200 behind the rolling shutter door assembly 310 to slide horizontally. The sliding shutter door assembly 320 includes a plurality of vertically extending members 322 stacked together and horizontally adjustable with respect to each other to create a second adjustable access point 324. For example, as shown in FIG. 6C, a half of the plurality of horizontally extending members 312 of the rolling shutter door assembly 310 moves upward along a y-axis from an origin ‘0’ and the other half moves downwards along a −y-axis from the origin ‘0’ to form the first adjustable access point 314. Similarly, a half of the plurality of vertically extending members 322 of the sliding shutter door assembly 320 moves one side along a x-axis from the origin ‘0’ and the other half moves along the other side on −x-axis from the origin ‘0’ to form the second adjustable access point 324. The first and second adjustable access points 314, 324 coincide together to collectively configure the adjustable access point 110 to access the package from the respective pallet 220 of the respective rack 210.

In one embodiment of the present disclosure, the adjustable door assembly slidably 300 further includes a rolling shutter door storage 330 and a sliding shutter door channel 340. The rolling shutter door storage 330 may be coupled to the rolling shutter door assembly 310 to store the rolling shutter door assembly 310 when the rolling shutter door assembly 310 is slid vertically to create the first adjustable access point 314. Further, the sliding shutter door channel 340 may be coupled to the sliding shutter door assembly 320 to slid the rolling shutter door assembly 310 one above the other when the sliding shutter door assembly 320 is slid horizontally to create the second adjustable access point 324.

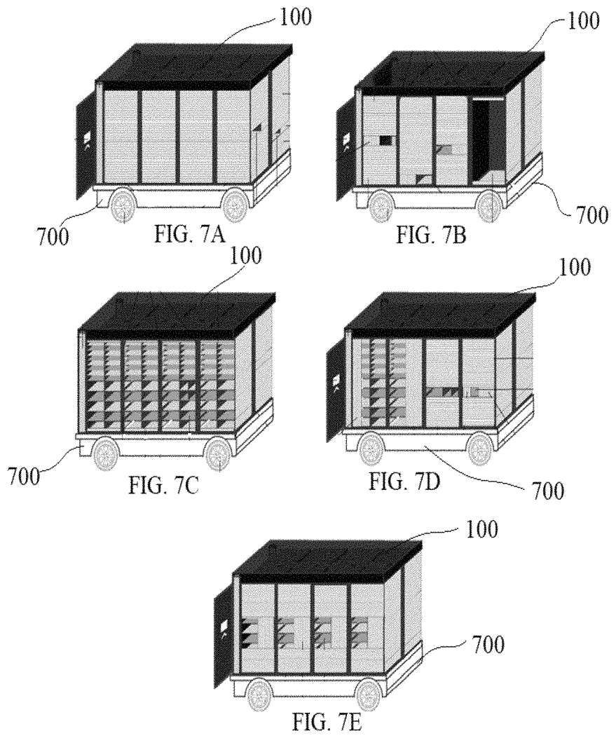

In various embodiments, the package locker unit 100 is installed on one of a driverless vehicle, and a vehicle with a driver or on a stationary structure or installed independently. For example, as shown in FIGS. 7A to 7E, the package locker unit 100 may be installed on a moving structure, such as vehicle 700. Such vehicle 700 may be driverless vehicle or a vehicle with a driver. FIGS. 7A to 7E illustrates various the package locker unit 100 is different states, for example FIG. 7A illustrates the package locker unit 100 installed on the vehicle 700 where two opening, such as the adjustable access points 110, are shown. FIGS. 7B to 7E illustrate the package locker unit 100 with various opening, such as the adjustable access points 110.

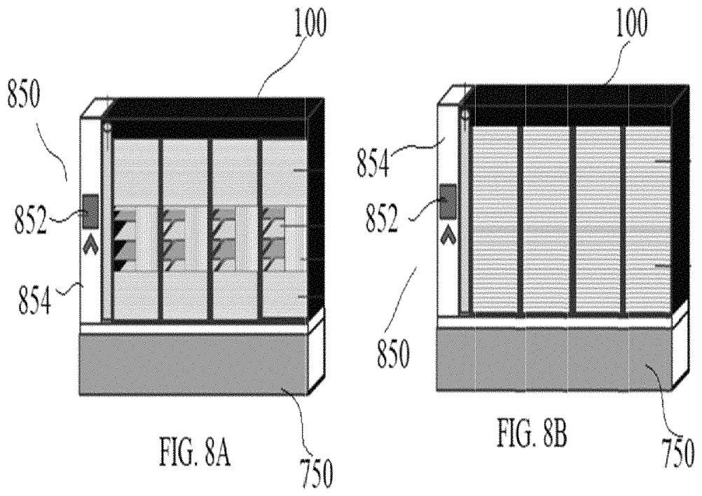

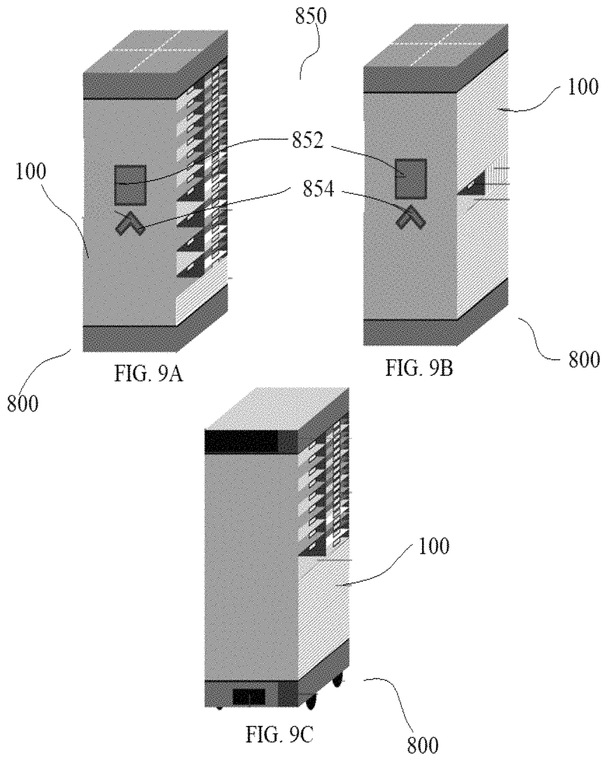

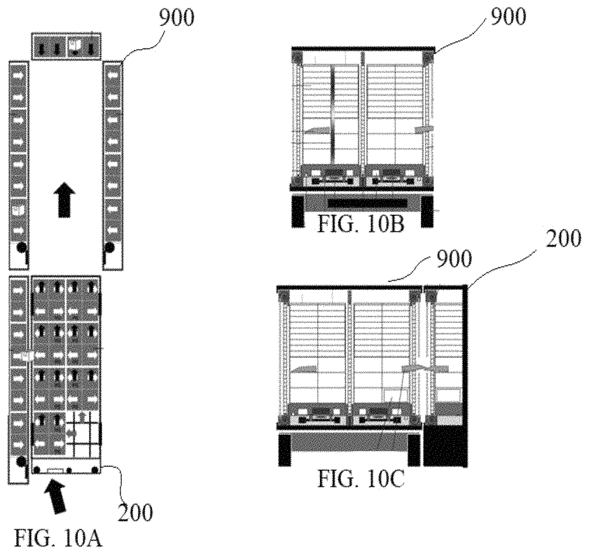

Further, as shown in FIGS. 8A and 8B, the package locker unit 100 may be installed on a stationary structure, such as structure 750. Furthermore, as shown in FIGS. 9A, 9B and 9C, the package locker unit 100 may be installed independently 800, without any moving or stationary structures. Moreover, where the package locker unit 100 is installed on the stationary structure 750 or installed independently 800, such the package locker unit 100 may also includes stationary pallet tower 900, as shown in FIG. 10A in which a moving pallet tower, such as the pallet tower 200, as shown in FIGS. 10B and 10C, place the package that may be delivered. In both such embodiments, the package locker unit 100 may include a scanner system 850, which may include a scanner 852 and electrical support and supply member 854 to functioning of the package locker unit 100. The scanner system 850 may be functionally similar to the pallet slot ID 250.

Referring back to FIG. 1, as mentioned above, the package delivery system 1000 includes the control network 400. The package locker unit 100 may be mounted on the package delivery vehicle, as described above. The package delivery vehicle may be preferably an automated delivery vehicle or driverless vehicle. In one embodiment of the present disclosure, the delivery vehicle may be a human-driven vehicle. The delivery vehicles may be designed to go on top of any internal combustion engine (ICE) or Electric vehicle (EV) platform/skateboard. The pallet tower 200 may also be termed as slotted pallet tower which includes one or more pallet square or pallet sections inside the vehicle, as described above. The control network 400 includes a number of computer devices, networks, applications, sensors, mobile devices, and the like for facilitating management of package delivery. The management of package delivery includes organizing package information, organizing customer information, real-time tracking of packages and coordinating with the customers or authorized recipients for package pick up and delivery.

In one embodiment of the present invention, the control network 400 is configured to facilitate customized automatic operation of the at least one adjustable door assembly while loading and delivery of the one or more packages. The control network 400 is further configured to facilitate flexible stack formation inside the at least one pallet tower 104 for shelving the one or more packages according to different package sizes. Furthermore, the control network 400 may provide access of the package to its authorized recipient from the at least one adjustable access point, and restrict access of the package to a recipient other than the authorized recipient. The customized automatic operation of the at least one adjustable door assembly includes automatically opening and closing of the at least one adjustable access point during delivery of the one or more packages. The customized automatic operation of the at least one adjustable door assembly also includes automatically opening of the at least one door according to various sizes of the one or more packages to be loaded and delivered. Further, the control network 400 is in communication with a global positioning system (GPS) device 650 configured to identify locations including a source location, a destination location and a current location of each of the one or more packages.

In one embodiment of the present disclosure, the one or more packages to be delivered may arrive at a warehouse or a drop off-centre. Each of the one or more packages may be labelled with an ID label having necessary identification information with respect to the delivery of the packages. The ID label on the parcel may contain various identification information (ID), for example: address and contact number of the intended recipient, sender information, package content information, package weight, package size, bar code, QR code, delivery receipt number, bill number, order number, date, package handling instructions etcetera. The control network 400 via a scanner device, scans the label on the packages to read the given information. The information read by the scanner is inputted or fed into one or more databases 110 configured to store the various information as applicable. The one or more databases may include, but are not limited to at least one customer database, at least one package database and at least one courier database. The one or more databases 110 may be connected to the control network 400 via the communication network 600. In addition to the ID label of the packages, each of the plurality of slots is also provided with a slot ID and each of the plurality of pallets is also provided with a pallet ID. The ID label, slot ID and the pallet ID together help in identifying the exact location of the slotted pallet on which the respective package resides. Each of the IDs may include may include alphanumeric usernames, words, numbers, symbols, and may be used to identify a particular customer, the pallet tower 100, pallet, slot, bay, rack, vehicle, package etc, in the process of managing the package delivery.

As explained above, each of the parcel package is labelled with ID label which is entered into the one or more databases 500 and thereafter used along with the slot ID and pallet ID, such as the pallet slot ID 250, by the control network 400 for making appropriate loading and delivery of the packages. The control network 400 is configured to facilitate the process of sorting of packages, manual or automated loading of packages, identifying delivery routes, routing the packages correctly to the intended warehouse and/or vehicles. While the packages are being loaded into the pallet tower 200, by automated or manual loading process, the ID label of each package is scanned, and the pallet is loaded in appropriate slot. The slot ID label is recorded corresponding to the ID label of the accommodated package. The control network 400 tracks the package and slot pallet location. The slot ID label also contains the pallet ID information. The slot ID and the ID label of the package residing in is recorded by the control network 400.

The pallet tower 400 is preloaded with the one or more packages, are thereafter loaded into the delivery vehicles. The vehicle is associated with a scanner system, such as the scanner system 850 for scanning the tower 200 pallet to ensure correct loading of the pallet and location of the pallet in vehicle. The control network 400 will track or monitor, which pallet is loaded in which vehicle, and which pallet is on which pallet square. Inputs from the scanner devices are sent to the control network 400 which thereby analyse the data and identifies the exact location of package, i.e., on which slot, on which pallet, on which pallet square, and on which vehicle the package is to be loaded. The embodiments as disclosed herein advantageously fill the gaps and addresses the deficiencies of the existing solutions by delivering parcel packages to the customer via autonomous driving technology. This also includes using the vehicle layout in a more efficient way wherein loading and unloading of pallet towers may be achieved remotely without involving human labor.

The control network 400 analyses the customer database to identify details of recipient customers to whom the packages are to be delivered. The identified recipient customers are contacted by making a phone call, sending message texts, emails, or notification alert on respective user devices, to inform the recipient customers about the scheduled deliveries. The recipient customers may be informed about the estimated delivery date, time, and location etc. The message texts and/or notification alerts may be sent on the user devices via one or more computer applications. In various embodiments of the present disclosure, the one or more computer applications may include one or more web applications and one or more mobile applications. The one or more computer applications may be installed and executed on the user device via a central server. The customers may subscribe to the package delivery services by securely registering their profiles on the central server.

The recipient customers may be contacted by the control network 400 to pick up the package with estimated arrival time and location, and may request confirmation from the customer. In the event, the customer is not available to pick up the package, the recipient customers may be asked to indicate alternative arrangements to collect the package.

In one embodiment of the present disclosure, a reminder call or message may be sent to the recipient customer before estimated arrival time so that they may to go to a pre-decided pick-up location for receiving the package by presenting their package code. The duration of the reminder call may be pre-set to few minutes before the estimated arrival time. The package code may include a number, a bar code, a QR code and the likes. The pre-decided pick-up location may include convenient curbside location for collecting their package. The delivery vehicle may arrive on the pre-decided location to deliver the packages to customers. The customers, may approach the vehicle and after identification of the customer, the customer may be provided with the package code. Customer may then be required to input the package code into the scanner device.

Once the package code is entered into the scanner device, the control network 400 locates the package and slot and the screen of the scanner device shows or indicates the package location to the customer. The customer is also informed about the time remaining for the adjustable access point to be opened. The customer may accordingly reach near the package location and await to receive the package from the access point. For example, the customer may be instructed to reach at bay#1 and may be informed that the access point will be opened in 10 seconds. Thereafter, the control network 400 instructs the adjustable door assembly, viz. the sliding shutter door and the roller shutter door to open at the corresponding slot and create an opening or the access point there. The shutter roller doors open to create an access point at the package slot wherein the customer's package is released. The customer thereby retrieves the package. In various embodiments of the present disclosure, the at least one adjustable door assembly is designed to dynamically open an access point at any area of the door to allow retrieval of the package.

Once the package is delivered, the tray arm of the access point experiences a drop in pressure and the shutter doors thereby start to close after a warning or an alert signal. The robotic mechanism of the locker 100 beeps a ‘THANK YOU’ message. The above explained steps and processes of delivering a package are repeated for the delivery of remaining packages of the delivery system to other customers. The system also attempts to make the deliveries that were missed during the first attempt delivery. The customers are accordingly contacted and the delivery is made later in the day. Once the deliveries are made, the one or more databases 500 are updated by the control network 400. The control network 400 is further configured to maintain an account of the remaining parcels accommodated in the delivery vehicle and any stationary locker, such as locker 900. The control network 400 matches up packages to available locker slots for unloaded. The match needs the slots to be the same height and the packages need to be able to fit into the receiving slot, so a smaller package in a larger slot is acceptable. The control network 400 is further configured to move the at least one pallet tower 100 around on delivery vehicle to increase the number matches between of package and slot. This will facilitate in increasing the number of matches efficiently and optimally. The control network 400 performs calculation of total number of slots and accordingly reserve one or more slots for respective packages. This facilitates in reducing any conflicts in slot bookings and also the chances of redundant booking or double booking of slots may be reduced effectively. Any remaining package may be returned to the warehouse. Any remaining packages that are expired or not claimed by the recipient costumer, may be returned to the sender. The customer databases may accordingly be updated. The delivery vehicle thereafter unloads the used tower pallet 100 at the warehouse. The one or more packages are sorted out to the appropriate loading zones and are accordingly loaded into a new empty tower pallet 200 for locker 100 delivery. This allows the delivery vehicle to be reloaded quickly and efficiently. In various embodiment of the present disclosure, the locker 100 delivery system may load the delivery vehicle during the evening and late night time so that to ensure that the lockers 100 are loaded up for the next day deliveries. The control network 400 may also analyze and arrange which package must go into which slot and into which locker 100. The vehicle will accordingly move and reach to a number of locker 100 locations to ensure all the lockers 100 are full and ready for the next day. Further, the delivery vehicle will approach the locker 100 and park in close proximity to the stationary locker 100. As the vehicle stops and parks, both rolling shutter doors and the sliding doors opens completely to expose all the slots on both devices. The vehicle and the locker 100 are thus ready to exchange packages. After the first exchange the pallets in the vehicle may move down one square and another round of exchanges can begin. The entire process is controlled and managed by the control network 400.

After a first locker, such as locker 200 exchange process is completed, the delivery vehicle may initiate another exchange on another such locker. The stationary locker 900 set up can be formulated in a number of ways including side by side transfer, side and front transfer. When the vehicle is in place, the pallets on the vehicle can be moved and more matches may be allowed for downloads.

The packages being loaded are scanned and loaded into the pallets slot. The pallet, the location of the packages, and its corresponding slot are recorded in the control network 400. The shutter doors are then rolled to create an access point around the corresponding slot. This limits access to only the corresponding slot shelf, so that the customer may access their specific package while keeping the other packages on vehicle secure. The rolling shutter doors can be adjusted to accommodate any size package so the door assembly and shelving mechanism may be adjusted according to the requirement and use the space within a vehicle in a more efficient manner as explained above.

The shelving pallets are with different formations, designs, sizes and types like refrigerated pallets, heated pallets etc. The shutter doors are configured via the control network 400 such that it opens and closes to any size of the pallet. The shutter rollers doors can be set up to be a tower pallet size or large as a full side of the vehicle can preferably be large shutter doors.

Further, the shutter roller doors and the sliding doors allow the formation of the at least one access point anywhere on the panel of any size as long as the access point is smaller than the panel size. This allows the package locker a flexibility of changing the inner slot(shelves) sizes to better meet the demands of the customer without making all new doors. The ability to open up completely and have roller doors that don't protrude out from the side of the truck allows it to dock/drive extremely close to one another and allow rapid loading and unloading of packages between the two lockers system. The loading can be completed by loading trays that would bridge the gap and move the package forward into the destination slot.

Further, the embodiments as disclosed herein also address the package sorting and retrieval tasks in optimum time. With automated mechanism, the packages are stored on pallets with individually sectioned-off shelving units that cover 100% of the vehicle capacity wherein each individual package has its specific secured slot. According to the size of the package, the slot size is selected and matched. If the package size is found fit for the slot size, the package is placed and the location is recorded. This allows the system to use the space in the vehicle to its maximum and reduce wastage of space. The slots being shelved are based on pallets. The pallets can be exchanged easily and quickly. The pallet selection can be customized to meet the needs of the courier/customers on a day to day based. The pre-sorted packages are easy to locate and so more time can be allocated to driving to the next delivery. This eventually helps in completing more deliveries during the day by one truck/delivery vehicle. This further facilitates in providing services to multiple customers at the same time as a secondary control network panel can be added. Further, the customers may be allowed by the control network to access the packages via a phone app that would reduce contact with the vehicle thereby providing contactless delivery the customers and in a pandemic like situation.

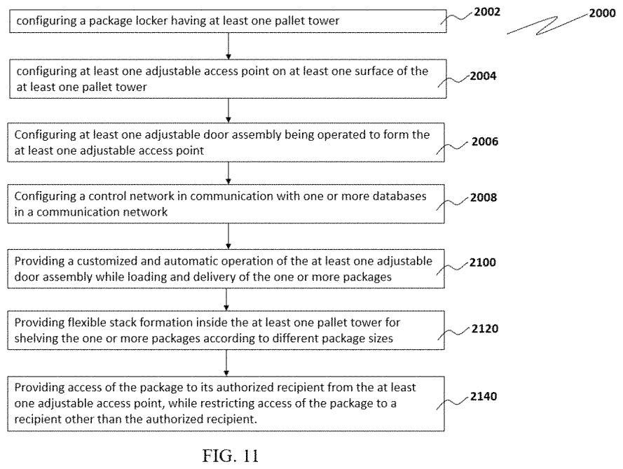

Now referring to FIG. 11, which 2 illustrate a method 2000 for providing automated delivery management of one or more packages, according to an exemplary embodiment of the present invention. The method may be initiated at step 2002 by configuring a package locker having at least one pallet tower. The pallet tower includes racks placed one above the other, as describe above and excluded herein for the sake of brevity.

At step 2004, at least one adjustable access point is configured, as describe above and excluded herein for the sake of brevity. At step 2006, at least one adjustable door assembly is configured to be operated to form the at least one adjustable access point, as describe above and excluded herein for the sake of brevity.

At step 2008, the control network 400 in communication with one or more databases in a communication network 600 is configured. The control network 400 facilitates customized automatic operation of the at least one adjustable door assembly while loading and delivery of the one or more packages. Furthermore, the control network 400 may provide access of the package to its authorized recipient from the at least one adjustable access point, and restrict access of the package to a recipient other than the authorized recipient. Further, the control network 400 is in communication with a global positioning system (GPS) device 650 configured to identify locations including a source location, a destination location and a current location of each of the one or more packages and establish communication with the control network 400 and the communication network 600.

At step 2100, customized and automatic operation of the adjustable door assembly is provided while loading and delivery of the one or more packages. The customized automatic operation of the at least one adjustable door assembly includes automatically opening and closing of the at least one adjustable access point during delivery of the one or more packages. The customized automatic operation of the at least one adjustable door assembly also includes automatically opening of the at least one door according to various sizes of the one or more packages to be loaded and delivered.

At step 2120, flexible stack formation inside the at least one pallet tower 200 for shelving the one or more packages according to different package sizes is provided. The control network 400 analyses the size of pallets and available location for a package on a pallet. The control network 400 facilitates the flexible stack formation inside the at least one pallet tower 400 by making use of the space according to size of the pallet and the package. In various embodiments of the present disclosure, the at least one adjustable door assembly is configured or programmed to be opened and closed on the X and Y-axis of locker side surface. This allows the door to open the access point anywhere as required, and also have the access point to be as small or as big as needed. This setup allows for extreme flexibility of shelving formation, sizing, and location of the access points. The shutter door system may thus be implemented for small packages or large packages by adjusting the inner shelves and indicating to the control network 400 of the changed shelving slot formation. The roller shutter doors system provides access to anyone's particular package at any time while at the same time restricting access to the other parcel packages. The computer network will coordinate which packages are to be released to which customers, the locker will confirm which customer is present and which package is to be released. The network 400 tells the shutter doors to open access point to allow the correct package to be released to the customer. Once the package is retrieved the network will close the shutter door and delivery is noted.

At step 2140, access of the package to its authorized recipient from the at least one adjustable access point is provided, while restricting access of the package to a recipient other than the authorized recipient. The customer database is analysed to identify details of recipient customers. The identified recipient customers are contacted by making a phone call, sending message texts, emails, or notification alert on respective user devices, to inform the recipient customers about the scheduled deliveries. The recipient customers may be informed about the estimated delivery date, time, and location etc. The message texts and/or notification alerts may be sent on the user devices via one or more computer applications including one or more web applications and one or more mobile applications. The one or more computer applications may be installed and executed on the user device via a central server via a communication network. The customers may subscribe to the package delivery services by securely registering their profiles on the central server. The recipient customers may be contacted by the control network 400 to pick up the package with estimated arrival time and location, and may request confirmation from the customer. In the event, the customer is not available to pick up the package, the recipient customers may be asked to indicate alternative arrangements to collect the package. The recipient customer may be verified before being authorised to receive the requested package. Thereafter, the control network 400 instructs the adjustable door assembly, viz. the sliding shutter door and the roller shutter door to open at the corresponding slot and create an opening or the access point there. The shutter roller doors open to create an access point at the package slot wherein the customer's package is released. The verified and authorized customer thereby retrieves the package. In case the customer is not verified by the details provided, the access point is not opened and the customer is denied to retrieve the requested package.

The term exemplary is used herein to mean serving as an example. Any embodiment or implementation described as exemplary is not necessarily to be construed as preferred or advantageous over other embodiments or implementations. Further, the use of terms such as including, comprising, having, containing and variations thereof, is meant to encompass the items/components/process listed thereafter and equivalents thereof as well as additional items/components/process.

Although the subject matter is described in language specific to structural features and/or acts, it is to be understood that the subject matter defined in the claims is not necessarily limited to the specific features or process as described above. In fact, the specific features and acts described above are disclosed as mere examples of implementing the claims and other equivalent features and processes which are intended to be within the scope of the claims.

What claimed is:

1. A package delivery system for automated delivery management of one or more packages, the system comprising:
at least one package locker unit having at least one adjustable access point, the at least one package locker unit comprising at least one pallet tower,
the at least one pallet tower having:
a plurality of racks placed one above the other, each rack of the plurality of racks being adjustable with respect to adjacent racks of the plurality of racks,
each rack of the plurality of racks having a plurality of pallets placed adjacent to each other for form the rack, wherein each pallet of the plurality of pallets are movable with respect to other pallet, each pallet accommodating a package of one or more packages to be delivered;
at least one adjustable door assembly slidably coupled to the at least one pallet tower, the at least one adjustable door assembly is adjected to provide the at least one adjustable access point to access the package accommodated on a respective pallet of the plurality of pallet of a respective rack of the plurality of racks, the at least one adjustable door assembly having:
a rolling shutter door assembly coupled to the at least one pallet tower to slide vertically, the rolling shutter door assembly including a plurality of horizontally extending members stacked together and vertically adjustable with respect to each other to create a first adjustable access point,
a sliding shutter door assembly coupled to the at least one pallet tower behind the rolling shutter door assembly to slide horizontally, the sliding shutter door assembly including a plurality of vertically extending members stacked together and horizontally adjustable with respect to each other to create a second adjustable access point,
wherein the first and second adjustable access points coincide together to collectively configure at least one adjustable access point to access the package from the respective pallet of the respective rack;
a control network communicably coupled to the at least one package locker unit 100, the control network configured to:
facilitate customized automatic operation of the at least one adjustable door assembly while loading and delivery of the one or more packages,
facilitate flexible stack formation inside the at least one pallet tower for shelving the one or more packages according to different package sizes,
provide access of the package to its authorized recipient from the at least one adjustable access point, and
restrict access of the package to a recipient other than the authorized recipient.

2. The system of claim 1, wherein the package locker unit is installed on one of a driverless vehicle and a vehicle with a driver or on a stationary structure or installed independently.

3. The system of claim 1, wherein the customized automatic operation of the at least one adjustable door assembly includes automatically opening and closing of the at least one adjustable access point during receiving or delivery of the one or more packages.

4. The system of claim 3, wherein the customized automatic operation of the at least one adjustable door assembly includes automatically opening of the at least one door according to various sizes of the one or more packages to be loaded and delivered.

5. The system of claim 1, wherein the control network is in communication with a global positioning system (GPS) device configured to identify locations including a source location, a destination location and a current location of each of the one or more packages.

6. The system of claim 1, wherein an identification (ID) label is allotted to each of the one or more packages.

7. The system of claim 6, wherein the identification (ID) label is implemented by the control network while storing, loading and delivering the one or more packages.

8. The system of claim 1, further comprising one or more databases 500 communicably connected to each other and with the control network in a communication network 600.

9. The system of claim 8, wherein the one or more databases includes:
at least one customer database configured to store details of one or more customers to whom the one or more packages are to be delivered;
at least one package database configured to store details of one or more packages; and
at least one courier database configured to store information of one or more warehouse or courier services.

10. The system of claim 1, wherein the at least one adjustable access point is being configured on dynamic locations on a surface of the at least one tower pallet.

11. The system of claim 1, wherein the control network is configured to perform analysis to uniquely arrange each of the one or more packages into respective slots, respective pallets, respective pallet tower and respective vehicle.

12. The system of claim 1, wherein the control network comprises one or more devices including computer devices, user devices, scanner devices, sensors, bar code readers, camera devices, mobile phones and computer networks for providing management of package delivery.

13. A package locker unit comprising:
at least one adjustable access point;
at least one pallet tower having:
a plurality of racks placed one above the other, each rack of the plurality of racks being adjustable with respect to adjacent top and bottom racks of the plurality of racks,
each rack of the plurality of racks having a plurality of pallets placed adjacent to each other for form the rack, wherein each pallet of the plurality of pallets are movable with respect to other pallet, each pallet accommodating a package of one or more packages to be delivered; and
at least one adjustable door assembly slidably coupled to the at least one pallet tower, the at least one adjustable door assembly is adjected to provide the at least one adjustable access point to access the package accommodated on a respective pallet of the plurality of pallet of a respective rack of the plurality of racks, the at least one adjustable door assembly having:
a rolling shutter door assembly coupled to the at least one pallet tower to slide vertically, the rolling shutter door assembly including a plurality of horizontally extending members stacked together and vertically adjustable with respect to each other to create a first adjustable access point,
a sliding shutter door assembly coupled to the at least one pallet tower behind the rolling shutter door assembly to slide horizontally, the sliding shutter door assembly including a plurality of vertically extending members stacked together and horizontally adjustable with respect to each other to create a second adjustable access point,
wherein the first and second adjustable access points coincide together to collectively configure at least one adjustable access point to access the package from the respective pallet of the respective rack;

14. The package locker unit as claimed in claim 13 further comprising a slidable arrangement to slidably engage the plurality of racks to be placed one above the other and be adjustable with respect to each of the adjacent top or bottom racks of the plurality of racks to define an adjustable slot between the adjacent top and bottom racks.

15. The package locker unit as claimed in claim 13 further comprising a support structure disposed below the at least one pallet tower, the support structure having a channel.

16. The package locker unit as claimed in claim 13 further comprising a pallet slot corresponding to each pallet of the plurality of pallets.

17. The package locker unit as claimed in claim 13, wherein each pallet of the plurality of pallets comprises a plurality of pallet square, each pallet square movably coupled to each of an adjacent pallet square.

18. The package locker unit as claimed in claim 13 further comprising a pallet track system operatively coupled to the plurality of pallets to load the plurality of pallets and to maneuver the plurality of pallets within the at least one pallet tower.

19. The package locker unit as claimed in claim 13, wherein at least one adjustable door assembly slidably further comprises:
a rolling shutter door storage coupled to the rolling shutter door assembly to store the rolling shutter door assembly when the rolling shutter door assembly is slid vertically to create the first adjustable access point, and
a sliding shutter door channel coupled to the sliding shutter door assembly to slid the rolling shutter door assembly one above the other when the sliding shutter door assembly is slid horizontally to create the second adjustable access point.

20. A method for facilitating delivery management of one or more packages, the method comprising:
configuring a package locker having at least one pallet tower;
configuring at least one adjustable access point on at least one surface of the at least one pallet tower, the at least one pallet tower having:
a plurality of racks placed one above the other, each rack of the plurality of racks being adjustable with respect to adjacent racks of the plurality of racks,
each rack of the plurality of racks having a plurality of pallets placed adjacent to each other for form the rack, wherein each pallet of the plurality of pallets are movable with respect to other pallet, each pallet accommodating a package of one or more packages to be delivered via the at least one adjustable access point;
at least one adjustable door assembly slidably coupled to the at least one pallet tower, the at least one adjustable door assembly is adjected to provide the at least one adjustable access point to access the package accommodated on a respective pallet of the plurality of pallet of a respective rack of the plurality of racks,
the at least one adjustable door assembly having:
a rolling shutter door assembly coupled to the at least one pallet tower to slide vertically, the rolling shutter door assembly including a plurality of horizontally extending members stacked together and vertically adjustable with respect to each other to provide a first adjustable access point,
a sliding shutter door assembly coupled to the at least one pallet tower in front of the rolling shutter door assembly to slide horizontally, the sliding shutter door assembly including a plurality of vertically extending members stacked together and horizontally adjustable with respect to each other to provide a second adjustable access point,
wherein the first and second adjustable access points coincide together to collectively configure at least one adjustable access point to access the package from the respective pallet of the respective rack;
configuring a control network for:
facilitating customized automatic operation of the at least one adjustable door assembly while loading and delivery of the one or more packages,
facilitating flexible stack formation inside the at least one pallet tower for shelving the one or more packages according to different package sizes,
providing access of the package to its authorized recipient from the at least one adjustable access point, and
restricting access of the package to a recipient other than the authorized recipient.
